(19) United States
(12) Patent Application Publication
(10) Pub. No.: US 2010/0234105 A1
(43) Pub. Date: Sep. 16, 2010

(54) MAINTAINING GAME HISTORY IN WAGERING GAME SYSTEMS

(75) Inventors: Mark B. Gagner, West Chicago, IL (US); Timothy T. Gronkowski, Chicago, IL (US); Damon E. Gura, Chicago, IL (US)

Correspondence Address: WMS GAMING (DELIZIO GILLIAM);C/O DELIZIO GILLIAM, PLLC, 15201 MASON ROAD, SUITE 1000-312, CYPRESS, TX, 77433, US

(73) Assignee: WMS Gaming, Inc., Waukegan, IL (US)

(21) Appl. No.: 12/723,297

(22) Filed: Mar. 12, 2010

Related U.S. Application Data
(60) Provisional application No. 61/159,620, filed on Mar. 12, 2009.

(51) Int. Cl. A63F 13/00; A63F 9/24

(52) U.S. Cl. 463/30; 463/42; 463/43

(57) ABSTRACT

A wagering game system and its operations are described herein. In some embodiments, the operations can include initiating a secondary game for presentation on a wagering game machine. The secondary game may be associated with a primary wagering game being presented on the wagering game machine. The operations can also include detecting secondary game events associated with the secondary game; generating secondary game history based, at least in part, on the secondary game events; and generating a pointer to a storage location of the secondary game history. The operations can further include providing the pointer for the secondary game history to the wagering game machine to be stored within a primary wagering game history associated with the primary wagering game.

### RELATED APPLICATIONS

This application claims the priority benefit of U.S. Provisional Application Ser. No. 61/159,620 filed Mar. 12, 2009.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, WMS Gaming, Inc.

### FIELD

Embodiments of the inventive subject matter relate generally to wagering game systems, and more particularly to maintaining game history in wagering game systems.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments are illustrated in the Figures of the accompanying drawings in which:

FIG. 1 is conceptual diagram that illustrates an example of maintaining game history for both primary wagering games and secondary games, according to some embodiments;

FIG. 2 is a conceptual diagram that illustrates an example of a wagering game system architecture, according to some embodiments;

FIG. 3 is a flow diagram illustrating operations for maintaining primary and secondary game history, according to some embodiments;

FIG. 4 is a flow diagram illustrating operations for maintaining secondary game history, according to some embodiments

FIG. 5 is a flow diagram illustrating operations for replaying the secondary game in conjunction with the replay of the primary wagering game, according to some embodiments;

FIG. 6 is a conceptual diagram that illustrates an example of a wagering game machine architecture, according to some embodiments; and

FIG. 7 is a perspective view of a wagering game machine, according to example embodiments.

### DESCRIPTION OF THE EMBODIMENTS

This description of the embodiments is divided into five sections. The first section provides an introduction to some embodiments, while the second section describes example wagering game machine architectures. The third section describes example operations performed by some embodiments and the fourth section describes example wagering game machines in more detail. The fifth section presents some general comments.

### Introduction

This section provides an introduction to some embodiments.

Operators of wagering game machines (“operators”), e.g., casino operators, typically maintain game history for most of their primary wagering games (e.g., base games) that are run on wagering game machines. For example, operators utilize a server or other mechanism to monitor and store primary game events during game play, e.g., button presses, bets, credit balances, intermediate results, final game results, etc., which can be used to reproduce games and verify results. In some cases, operators may access primary game history for dispute resolution, e.g., a player of a wagering game (“player”) may dispute the results of the wagering game. It is noted, however, that operators may use primary game history for other purposes, e.g., to reconstruct games that were interrupted due to power loss, power surges, hardware/software failure, etc.

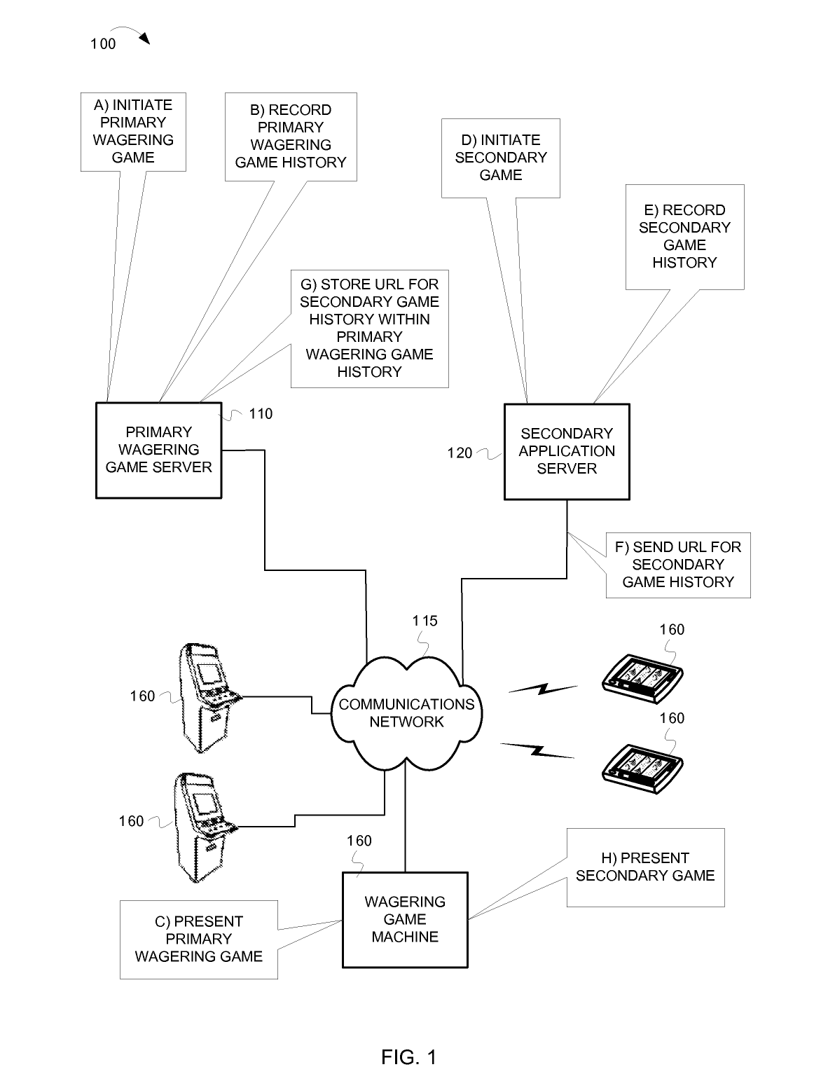

In various embodiments, a wagering game system (e.g., system 100 of FIG. 1) is configured to implement techniques for maintaining game history for both primary wagering games and secondary applications in the wagering game system. Secondary applications may include secondary games, such as bonus games, side games, etc., which are presented in conjunction with a primary wagering game at the wagering game machines. Secondary applications may also include other applications besides games, such as promotional applications, social networking applications, player tracking applications, or other casino services applications that are associated with the wagering game machines.

In some implementations, the secondary applications can include code that is packaged, compiled, and/or stored separately from code for the primary wagering games. The primary wagering games and the secondary applications can run separately (e.g., can run under separate processes, can have separate memory allocations, etc.), even though they may be run at the same time. During run time, the primary wagering games and the secondary applications can run in conjunction with each other (e.g., in connection with each other, pass data between each other, present or control common content or data, utilize each other's functionality, utilize each other's programming functions, methods, or protocols, access each other's data, are dynamically linked, etc.). In one example, the primary wagering games and the secondary applications can run in conjunction with each other via one or more application programming interfaces (APIs). Developers can develop the primary wagering games and the secondary applications separately, having separate program assets, content, code, etc. The secondary application code may not have to be compiled into the primary wagering game code, thus allowing the applications to have independent development times, independent internal development approval processes, independent external approval processes (e.g., jurisdictional gaming approvals), etc. Also, due to the runtime linking of the primary wagering games and secondary games, the number of combinations of games may be increased exponentially therefore resulting in a greater variety of play experiences for the operator and player. Additionally, the primary wagering games can have separate pay tables from the secondary games (e.g., for profit calculation and jurisdictional requirements). Furthermore, the primary wagering games and the secondary applications may be run using distinct technologies, e.g., secondary applications can be thin client or server-based applications, while primary wagering games can be thick client applications.

In one example, one or more secondary games may be integrated with functionality, information, or other features available from, or through, a primary wagering game. For instance, a primary wagering game may have wagering functionality and other game control features. The one or more secondary games may be configured to utilize the wagering functionality or other game control features of the primary wagering game to conduct wagers within the secondary game. Furthermore, in other examples, the primary wagering game can also have access to financial data or account information that the secondary games may need to access. Some embodiments, therefore, can provide the wagering functionality, financial data, account information, or other features and information of the primary wagering game, to the secondary games.

In some implementations, primary game history is stored within a primary wagering game server, and/or within the wagering game machines, for primary wagering games that are run on the wagering game machines. In these implementations, secondary game history is stored remotely from the primary wagering game server and the wagering game machines, e.g., within a secondary game server of the wagering game system, for secondary games that are run from the secondary game server (i.e., remote from the gaming machines). In some embodiments, the wagering game system implements game history techniques for generating, storing, and otherwise managing secondary game history, such that secondary game history is efficiently accessed remotely from the primary wagering game server (or the wagering game machines), and effectively replayed and synchronized with the playback of the corresponding primary wagering game. In some embodiments, the game history techniques may allow for management of secondary game history and playback of secondary applications in conjunction with the corresponding primary wagering games in heterogeneous wagering game system environments that comprise primary wagering games and secondary applications (e.g., secondary games) from different manufacturers.

FIG. 1 is conceptual diagram that illustrates an example of maintaining game history for both primary wagering games and secondary games, according to some embodiments. In FIG. 1, the wagering game system 100 (“system”) includes a primary wagering game server 110, a secondary applications server 120, and a plurality of wagering game machines 160 connected via a communication network 115. In one implementation, at stage A, the primary wagering game server 110 initiates a primary wagering game (e.g., slot games, electronic poker, electronic black jack, etc.) based on one or more player inputs detected by a wagering game machine 160. At stage B, the primary wagering game server 110 starts recording a primary wagering game history associated with the primary wagering game. For example, the primary wagering game server 110 may record the primary wagering game history based on events reported by the wagering game machine 160, e.g., button presses, bets, credit balances, intermediate results, final game results, etc. At stage C, the wagering game machine 160 presents the primary wagering game to the player, e.g. via a browser on a primary display of the wagering game machine 160.

At stage D, the secondary application server 120 initiates a secondary game (e.g., a bonus game), for example, after detecting a trigger event in the primary wagering game (e.g., max bet, particular game results, etc.) or detecting a player selection of a secondary game at the wagering game machine 160. At stage E, the secondary application server 120 starts recording a secondary game history associated with the secondary game. For example, the secondary application server 120 may record the secondary game history based on results it generates and secondary game events reported by the wagering game machine 160, e.g., button presses, bets, credit balances, intermediate results, final game results, etc. At stage F, the secondary application server 120 sends a Uniform Resource Locator (URL) for the secondary game history to the wagering game machine 160, which provides the URL to the primary wagering game server 110. In another example, the secondary application server 120 may provide the URL for the secondary game history directly to the primary wagering game server 110. It is noted, however, that in other implementations the secondary application server 120 may send an address, link or other type of pointer indicating the storage location of the secondary game history. At stage G, the primary wagering game server 110 records the URL for the secondary game history within the primary wagering game history. At a later time, during playback of the primary wagering game, the URL can be used to playback the secondary game in conjunction with the playback of the primary wagering game. At stage H, the wagering game machine 160 presents the secondary game, e.g., via a browser on a secondary display of the wagering game machine 160.

Although FIG. 1 describes some embodiments, the following sections describe many other features and embodiments.

### Operating Environment

This section describes example operating environments and networks and presents structural aspects of some embodiments. More specifically, this section includes discussion about wagering game system architectures.

### Wagering Game Machine Architectures

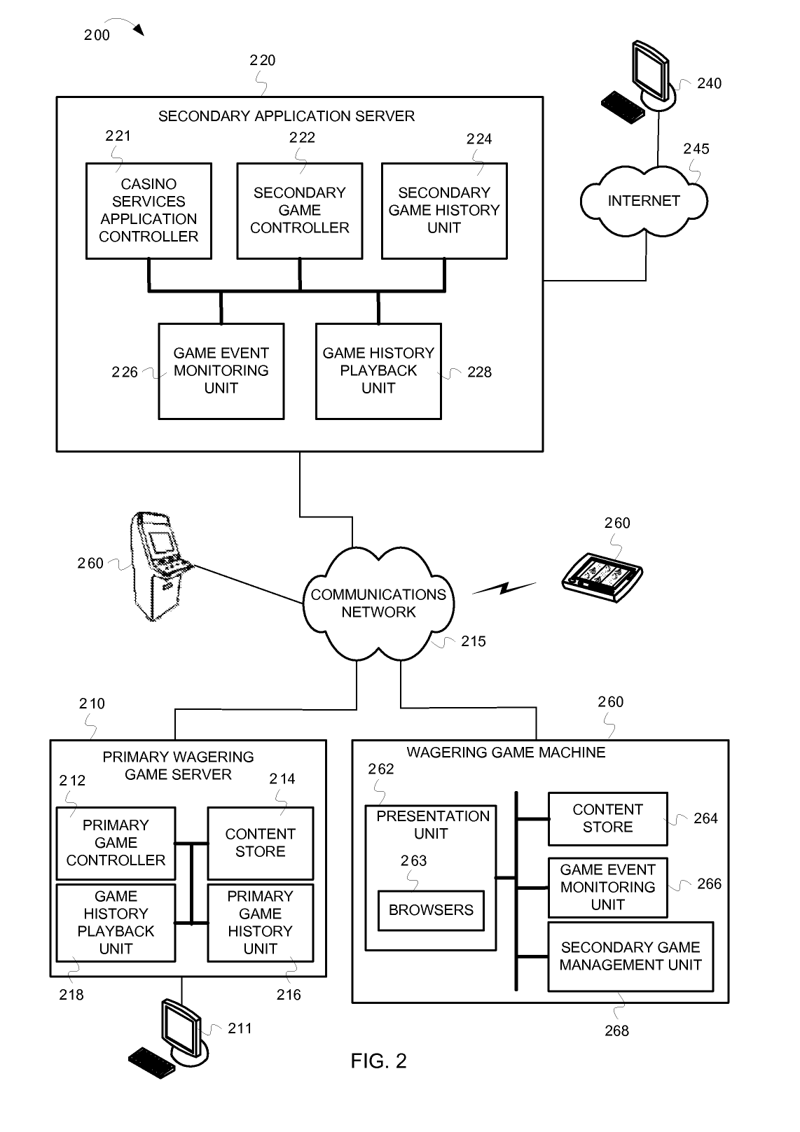

FIG. 2 is a conceptual diagram that illustrates an example of a wagering game system architecture 200, according to some embodiments. As illustrated, the wagering game system architecture 200 includes a primary wagering game server 210, a secondary application server 220, and a plurality of wagering game machines 260 connected via a communication network 215.

The primary wagering game server 210 is configured to manage and control primary wagering game content for presentation on the wagering game machines 260. Primary wagering game content can include primary wagering games that receive bets, produce chance results, and award winning results with money pay outs. Examples of primary wagering game content include primary game play elements that present game play, such as slot reels, poker cards, etc. The primary wagering game server 210 includes a primary game controller 212 configured to generate (e.g., using a random numbers generator) game results (e.g., win/loss values), including win amounts, for games played on the wagering game machines 260 (e.g., slots, poker, etc.). The primary game controller 212 can communicate the game results to the wagering game machines 260 via the network 215. In some implementations, the primary game controller 212 can also generate random numbers and provide them to the wagering game machines 260 so that the wagering game machines 260 can generate game results. The primary wagering game server 210 can also include a content store 214 configured to store the primary wagering game content.

The primary wagering game server 210 may include a primary game history unit 216 for storing primary wagering game history associated with the primary wagering games that are presented on the wagering game machines 260. The primary wagering game server 210 may also include a game history playback unit 218 for replaying primary wagering games (and associated secondary applications) based on the stored primary wagering game history. In some implementation, the primary wagering games (and associated secondary applications) can be replayed via terminal 211, e.g., for result verification purposes. It is noted, however, that in some implementations the game history can also be replayed at the wagering game machine 260 and/or in one or more displays (e.g., plasma displays) located on the casino floor, for example, for social networking purposes, promotional purposes, etc.

The secondary application server 220 is configured to manage and control secondary applications implemented within the wagering game system 200. Secondary applications may include secondary games, such as bonus games, side games, etc., which are presented in conjunction with a primary wagering game at the wagering game machines 260. The secondary games can provide monetary awards (e.g., credits) or non-monetary awards (e.g., points, merchandise, discounts, status rewards, perks, etc.) based on the secondary game results. As described previously, secondary applications may also include other applications besides games, such as promotional applications, social networking applications, player tracking applications, or other casino services applications that are associated with the wagering game machines 260. In some embodiments, the secondary application server 220 can also manage and control secondary applications that are implemented for online gaming, for example, secondary games that are presented on one or more remote systems 240 (e.g., a personal computer (PC) or a mobile device) to members of an online gaming community via the Internet 245.

The secondary application server 220 may include a casino services application controller 221, a secondary game controller 222, a secondary game history unit 224, a game event monitoring unit 226, and a game history playback unit 228. The secondary game controller 222 may be configured to manage and control secondary games for presentation on the wagering game machines 260. For example, the secondary game unit 222 can generate (e.g., using a random numbers generator) game results for the secondary games, and may also store secondary game content. The casino services application unit 221 can manage and control casino services applications, such as applications that provide players additional entertainment options (e.g., social networking applications), and applications that are implemented for the benefit of the operator (e.g., promotional applications). The secondary game history unit 224 can store secondary game history associated with the secondary applications of the secondary game unit 222 and of the casino services application unit 221. It is noted that secondary game history may be referred to herein as “secondary application history” because the secondary game history unit 224 can store history not only for the secondary games but also for the casino services applications, or any other secondary applications that are implemented between the secondary application server 220 and the wagering game machines 260. In some embodiments, secondary game history unit 224 can also store secondary game history for secondary applications implemented for online gaming, e.g., secondary games that are presented to members of an online gaming community.

The game event monitoring unit 226 is configured to detect secondary game events associated with the secondary games being presented on the wagering game machines 260. For example, game event monitoring unit 226 can monitor secondary game events reported by the wagering game machine, e.g., button presses, bets, etc., and secondary game events reported by the secondary game unit 222, e.g., secondary game results. The detected secondary game events can be used to store secondary game history. In some implementations, the secondary game history can include video clips of the secondary games that are recorded based on the secondary game events. In some implementations, the secondary game history can include a record of the secondary game events, which can be used at a later time to reproduce the secondary game. The game history playback unit 228 is configured to access the secondary game history stored in the secondary game history unit 224 to playback secondary wagering games in conjunction with the corresponding primary wagering game. In some implementations, the game history playback unit 228 may also store the secondary game history in the secondary game history unit 224 based on the detected secondary game events. Furthermore, the game history playback unit 228 may also send a URL (or other type of pointer) identifying the storage location of the secondary game history to the wagering game machine 260, in order to be stored within the primary game history.

The plurality of wagering game machines 260 are configured to present primary wagering games, secondary games, and other content for players. As illustrated in FIG. 2, in some implementations, each of the wagering game machines 260 includes a presentation unit 262, a content store 264, a game event monitoring unit 266, and a secondary game management unit 268. The presentation unit 262 is configured to control the presentation of primary wagering games and secondary games on the wagering game machine 260. The presentation unit 262 can include one or more browsers 263 and any other software and/or hardware suitable for presenting audio and video content. It is noted, however, that in other implementations the game content can be presented using other display technologies. The content store 264 can store content to present on the wagering game machine 260.

The game event monitoring unit 266 may be configured to detect primary wagering game events associated with the primary wagering games being presented on the wagering game machine 260. The game event monitoring unit 266 may report the detected primary wagering game events to the primary wagering game server 210 to store primary wagering game history. In some embodiments, the game event monitoring unit 266 can also store the primary wagering game history within the wagering game machine 260. The game event monitoring unit 266 can also detect secondary game events associated with the secondary games being presented on the wagering game machine 260. The game event monitoring unit 266 may report the detected secondary wagering game events to the secondary game management unit 268. The secondary game management unit 268 is configured to implement a messaging protocol to communicate with the secondary application server 220. In one example, the secondary game management unit 268 may implement the messaging protocol for communicating with the secondary application server 220 via a network socket interface. The secondary game management unit 268 can utilize the messaging protocol to report secondary game events associated with the secondary games being presented on the wagering game machine 260 to the secondary application server 220. The secondary game events can be used to generate secondary game history. In one example, the secondary game management unit 268 can report events that trigger the presentation of secondary games (e.g., max bet, button presses, primary game results), player inputs for interactive secondary games (e.g., button presses, screen touches), secondary game results, etc. The secondary game management unit 268 can receive, from the secondary application server 220, one or more pointers (e.g., a URLs) to storage locations of the secondary game history associated with the secondary games. The secondary game management unit 268 may store the pointer for the secondary game history within the primary wagering game history.

In one embodiment, the wagering game machines 260 can be casino floor wagering game machines (wired and/or wireless). It is noted, however, that in other embodiments the wagering game machines 260 can be laptops, desktop PCs, mobile phones, personal digital assistants (PDAs), etc. that have access to the network 215.

Each component shown in the wagering game system architecture 200 is shown as a separate and distinct element connected via a communications network 215. However, some functions performed by one component could be performed by other components. For example, the secondary game controller 222 can also be configured to perform some or all of the functions of the game event monitoring unit 226 and/or the game history playback unit 228. Furthermore, the components shown may all be contained in one device, but some, or all, may be included in, or performed by multiple devices, as in the configurations shown in FIG. 2 or other configurations not shown. Furthermore, the wagering game system architecture 200 can be implemented as software, hardware, any combination thereof, or other forms of embodiments not listed. For example, any of the network components (e.g., the wagering game machines, servers, etc.) can include hardware and machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable storage media includes read only memory (ROM), random access memory (RAM), magnetic disk storage media, optical storage media, flash memory machines, and other types of tangible medium suitable for storing instructions. Machine-readable transmission media includes any media suitable for transmitting software over a network.

Although FIG. 2 describes some embodiments, the following sections describe many other features and embodiments.

### Example Operations

This section describes operations associated with some embodiments. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

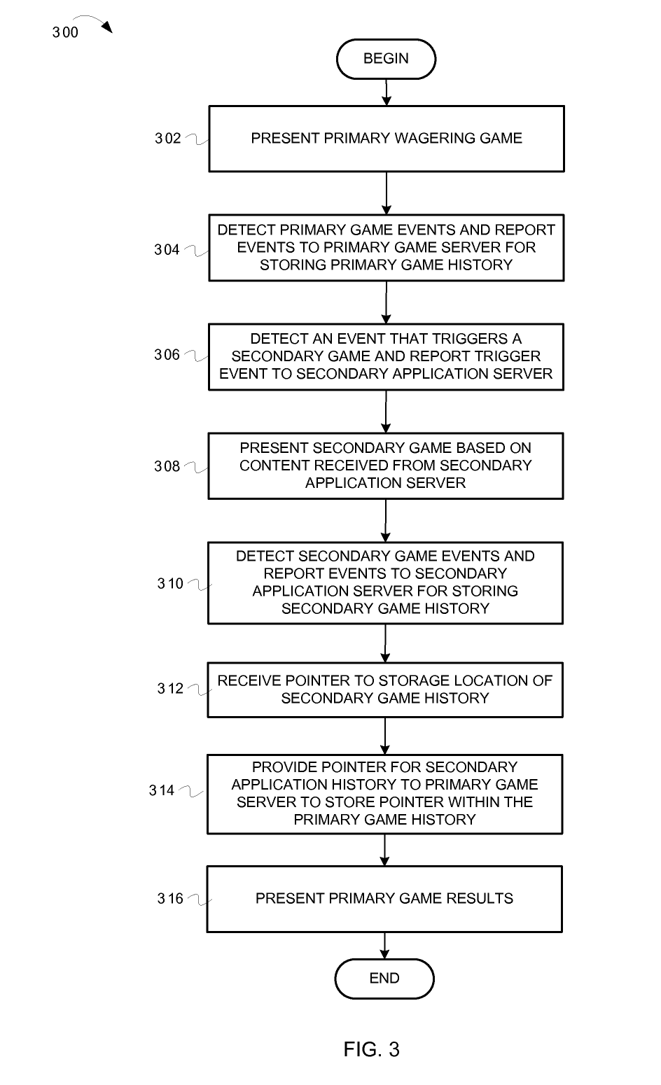

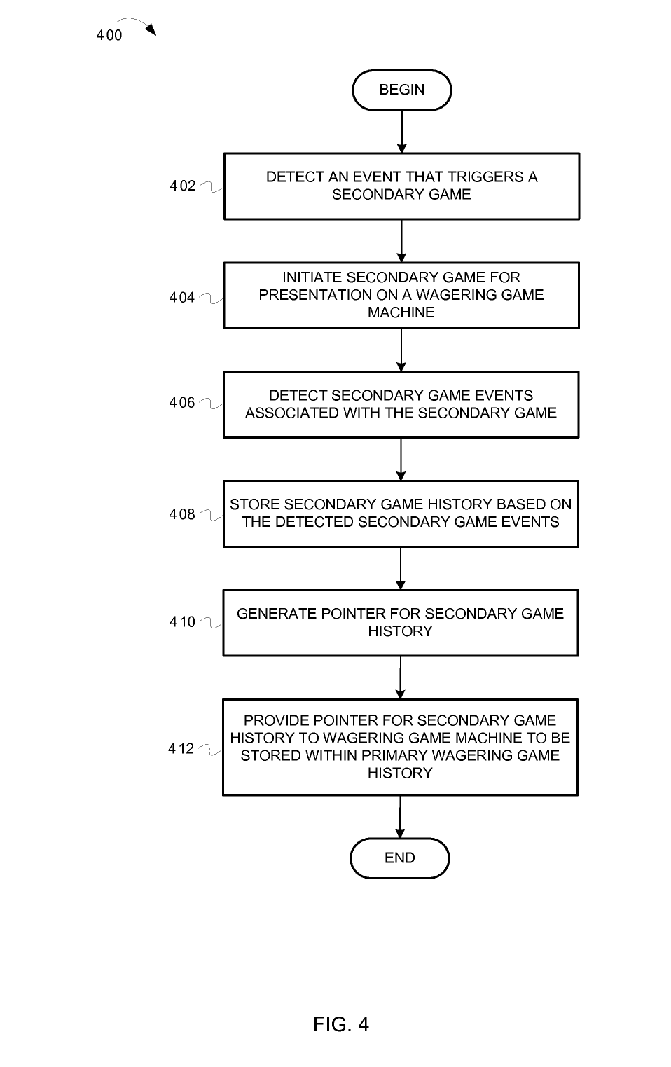

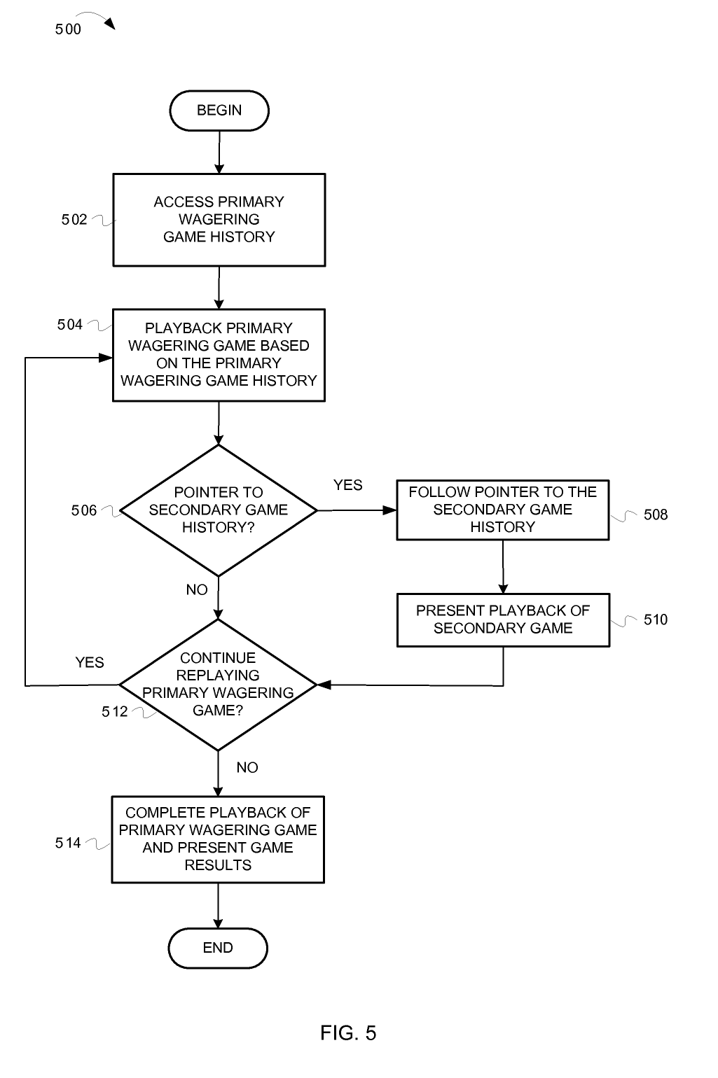

The following discussion of FIGS. 3-5 will describe interactions between a wagering game, a primary wagering game server, and a secondary application server for maintaining primary and secondary game history. FIGS. 3 and 4 describe how events associated with a primary wagering game and events associated with a corresponding secondary game are monitored, reported, and otherwise processed to generate primary and secondary game history. FIG. 5 described how a primary wagering game and a corresponding secondary game are replayed based on the primary and secondary game history.

FIG. 3 is a flow diagram (“flow”) 300 illustrating operations for maintaining primary and secondary game history, according to some embodiments. The flow of 300 will be described with reference to the example system architecture of FIG. 2. The flow diagram begins at block 302.

At block 302, a wagering game machine 260 presents a primary wagering game. For example, the game event monitoring unit 266 detects a player input to initiate a primary wagering game. In response to the game event monitoring unit 266 detecting the player input, the presentation unit 262 loads content associated with the primary wagering game (e.g., audio/video content) from the content store 264 and presents the content in a display of the wagering game machine 260. After block 302, the flow continues at block 304.

At block 304, the wagering game machine 260 detects primary wagering game events and reports the primary wagering game events to the primary wagering game server 210 to be used for generating primary wagering game history. For example, the game event monitoring unit 266 detects primary wagering game events, e.g., button presses, bets, credit balances, intermediate results, final game results, etc. The game event monitoring unit 266 then reports the events to the primary wagering game server 210 in order to store primary game history for the primary wagering game being presented on the wagering game machine 260. In some implementations, to generate game history for a primary wagering game, the game event monitoring unit 266 detects at least one or more starting events and one or more ending events. The game event monitoring unit 266 may also detect one or more intermediate events. The starting events may be events that indicate the start of the primary wagering game and events that set initial conditions and parameters for the start of the primary wagering game. For example, starting events may be the initial player input (game selection) that initiates the primary wagering game (e.g., a button press, screen touch, etc.), the player's credit balance, the initial bet amount, etc. The ending events may be events that indicate the end of the primary wagering game. For example, ending events may be the primary wagering game results, the player's ending credit balance, etc. In some examples, ending events such as the game results can trigger the start of a secondary game, e.g., a bonus game. Intermediate events may be events that take place between the starting and ending events. For example, intermediate events may be button presses, screen touches, intermediate results, secondary game triggers, etc. Furthermore, in some implementations, the game event monitoring unit 266 can also report the primary wagering game events to the secondary game management unit 268, e.g., to process secondary game event triggers. After block 304, the flow continues at block 306.

At block 306, the wagering game machine 260 detects a trigger event associated with a secondary game. For example, the game event monitoring unit 266 reports primary wagering game events to the secondary game management unit 268. The secondary game management unit 268 determines whether one or more of the primary wagering game events is a trigger event (e.g., max bet, a royal flush, a player selection, etc.) that trigger a secondary game (e.g., a bonus games). After detecting a trigger event, the secondary game management unit 268 can report the trigger event to the secondary application server 220 to initiate the secondary game. It is noted that some secondary games can be presented on the wagering game machine 260 during the context of the primary wagering game, but can be initiated independent of the primary wagering game events. For example, the secondary application server 220 can initiate some secondary games based on a player selection, a casino-wide jackpot game event, a casino-wide promotional event, etc. After block 306, the flow continues at block 308.

At block 308, the wagering game machine 260 presents a secondary game based on secondary game content received from the secondary application server 220. For example, the secondary game management unit 268 receives secondary game content from the secondary application server 220. Then, the presentation unit 262 presents the secondary game based on the secondary game content. The secondary game can be presented in the same display, or in a different display, of the wagering game machine 260 as the primary wagering game. After block 308, the flow continues at block 310.

At block 310, the wagering game machine 260 detects secondary game events and reports the secondary game events to the secondary application server 220. The secondary game events can be used for generating secondary game history at the secondary application server 220. In one implementation, the secondary game management unit 268 reports secondary game events to the game event monitoring unit 226 of the secondary application server 220. The secondary game events may include button presses, bets, credit balances, intermediate results, final game results, etc. In one example, for interactive secondary games (e.g., a bonus picking game) that are presented on the wagering game machine 260, the secondary game management unit 268 reports screen touches, button selections, or other player interactions associated with the secondary game to be used for generating secondary game history. It is noted that in some implementations random numbers used to determine game results, or the actual game results, are generated by the secondary game controller 222, and then reported to the game event monitoring unit 226. In other embodiments, game results may be generated by the wagering game machine 260, e.g., based on random numbers provided by the secondary game controller 222. In these embodiments, the secondary game management unit 268 may report the game results to the game event monitoring unit 226. As described above, the secondary game management unit 268 may implement a messaging protocol for communicating with the secondary application server 220, e.g., via a network socket interface. After block 310, the flow continues at block 312.

At block 312, the secondary game management unit 268 receives a pointer (e.g., URL) to the storage location of the secondary game history associated with the secondary game. For example, the secondary game management unit 268 receives the pointer from the game history playback unit 228 of the secondary application server 220. After block 312, the flow continues at block 314.

At block 314, the wagering game machine 260 provides the pointer for the secondary game history to the primary wagering game server 210 to store the pointer within the primary wagering game history. For example, the game event monitoring unit 266 may provide the pointer to the primary game history unit 216 to store the pointer within the primary wagering game history. In one example, the pointer allows the primary wagering game server 210 and/or the wagering game machine 260 to access the storage location (e.g., within the secondary game history unit 224) of the secondary game history to replay the secondary game in conjunction with the corresponding primary wagering game, e.g., for result verification purposes. In other words, the pointer (e.g., a URL) links the secondary game history (e.g., comprising a video clip of the secondary game) to the primary wagering history so that the secondary game is played in conjunction with the primary wagering game when the primary wagering game is replayed, as will be further described below. It is noted that in some implementations multiple pointers can be received for multiple secondary games that are played in conjunction with the primary wagering game. After block 314, the flow continues at block 316.

At block 316, the wagering game machine 260 presents the primary wagering game results. Additionally, the game event monitoring unit 266 can finish reporting primary wagering game events (e.g., primary wagering game results) to the primary wagering game server 210 in order to finish storing the primary wagering game history. Furthermore, the secondary game management unit 268 can finish reporting secondary game events to the secondary application server 220 in order to finish storing the secondary game history, e.g., to finish recording or otherwise generating a video clip of the secondary game being played in conjunction with the primary wagering game. After block 316, the flow ends.

FIG. 4 is a flow diagram (“flow”) 400 illustrating operations for maintaining secondary game history, according to some embodiments. The flow of 400 will be described with reference to the example system architecture of FIG. 2. The flow diagram begins at block 402.

At block 402, the secondary application server 220 detects an event that triggers the presentation of a secondary game in conjunction with a primary wagering game in a wagering game machine 260. For example, the game event monitoring unit 226 receives a message from the secondary game management unit 268 of the wagering game machine 260 reporting an event associated with the primary wagering game that triggers a secondary game, e.g., a max bet within the primary wagering game, a player selection of a secondary game, a slot reel combination, etc. After block 402, the flow continues at block 404.

At block 404, the secondary application server 220 initiates the secondary game for presentation at the wagering game machine 260. For example, the secondary game controller 222 of the secondary applications server 220 communicates with the secondary game management unit 268 (e.g., provides secondary game content) to initiate the presentation of the secondary game at the wagering game machine 260. After block 404, the flow continues at block 406.

At block 406, the secondary application server 220 detects secondary game events associated with the secondary game. For example, the game event monitoring unit 226 of the secondary application server 220 detects secondary game events that are reported by the secondary game management unit 268, e.g., button presses, bets, interactive game player inputs, credit balances, intermediate results, final game results, etc. In some embodiments, the game event monitoring unit 226 detects at least a portion of the secondary game events from the secondary game controller 222, e.g., random numbers generated by the secondary game controller 222 to determine game results, intermediate game results, and/or final game results. After block 406, the flow continues at block 408.

At block 408, the secondary application server 220 stores secondary game history based on the detected secondary game events. In some implementations, the secondary game history can include a video clip of the secondary game that is recorded based on the secondary game events. For example, in addition to the secondary game controller 222 initiating the presentation of the secondary game at the wagering game machine 260, the game history playback unit 228 records or otherwise creates a video clip of the secondary game that is being presented at the wagering game machine 260 for the secondary game history. In one example, for non-interactive secondary games, the random numbers generated (e.g., by secondary game controller 222) determine the secondary game results and therefore determine at least a portion of the content of the secondary game. In another example, for interactive secondary games (e.g., picking games), interactive player inputs (e.g., screen touches, button presses, etc.) that are reported by the secondary game management unit 268 determine a portion of the content of secondary game, in addition to the secondary game results. In this example, for interactive games, the game event monitoring unit 226 monitors these types of secondary game events reported by the secondary game management unit 268 to determine the content of the secondary game and therefore the content of the corresponding video clip for the secondary game history. In some implementations, the secondary game history can include a record of the secondary game events, which can be used to reproduce the secondary game. For example, the secondary game history can include a record of screen touches, button presses, bets, game results, etc. that are reported by the secondary game management unit 268. In this example, the record of secondary game events can be used to generate a video clip of the secondary game, or to otherwise reproduce and playback the secondary game. After block 408, the flow continues at block 410.

At block 410, the secondary application server 220 generates a pointer to a storage location of the secondary application history. For example, the game history playback unit 228 can generate a pointer (e.g., a URL) to the storage location of the video clip for the secondary game history. In another example, the game history playback unit 228 can generate a pointer to the storage location of the secondary game events, which can be used to reproduce the secondary game. In some implementations, some of the stored secondary event information can be pointers to additional information, e.g., game assets or other game content, stored within the same server and/or within other servers. After block 410, the flow continues at block 412.

At block 412, the secondary application server 220 provides the pointer for the secondary game history to the wagering game machine 260. In one example, the pointer for the secondary game history is stored within the primary wagering game history of the primary wagering game server 210 and/or of the wagering game machine 260. After block 412, the flow ends.

FIG. 5 is a flow diagram (“flow”) 500 illustrating operations for replaying the secondary game in conjunction with the replay of the primary wagering game, according to some embodiments. The flow of 500 will be described with reference to the example system architecture of FIG. 2. The flow diagram begins at block 502.

At block 502, the primary wagering game server 210 accesses the primary wagering game history associated with a primary wagering game. For example, the game history playback unit 218 can access the primary wagering game history stored within the primary wagering game history unit 216. In some cases, operators (e.g., casino operators) may access the primary and secondary game history for dispute resolution, e.g., a player may dispute the results of the primary and/or secondary wagering game. It is noted, however, that operators may use the primary and secondary game history for other purposes, e.g., to reconstruct games that were interrupted due to power loss, power surges, hardware/software failure, etc. Furthermore, it is noted that the primary and secondary wagering game history can be accessed from other network components. In some implementations, the primary and secondary wagering game history may be accessed from a wagering game machine 260. For example, a player may access the primary and/or secondary wagering game history of the top five winning games for that player via a wagering game machine 260, e.g., for bragging purposes within the social network offered by the casino. In another example, operators may access the primary and secondary game history for promotional purposes, e.g., display a recent win in plasma displays around the casino floor. After block 502, the flow continues at block 504.

At block 504, the primary wagering game server 210 begins to playback the primary wagering game based on the primary wagering game history. For example, the game history playback unit 218 begins to replay the primary wagering game on the terminal 211 or a wagering game machine 260. In some implementations, the primary wagering game is replayed based on the primary wagering game events that comprise the primary wagering game history. After block 504, the flow continues at block 506.

At block 506, the primary wagering game server 210 determines whether a pointer (e.g., a URL) to a secondary game history associated with a secondary game has been detected within the primary wagering game history. If a pointer has been detected, the flow continues at block 508. Otherwise, the flow continues at block 514.

At block 508, the primary wagering game server 210 follows the pointer to the storage location of the secondary game history. For example, the game history playback unit 218 follows the pointer and accesses the secondary game history within the secondary game history unit 224. After block 508, the flow continues at block 510.

At block 510, the primary wagering game server 210 presents the playback of the secondary game in conjunction with the playback of the primary wagering game. In one example, when the primary wagering game server 210 follows the pointer to the storage location of the secondary game history, the secondary application server 220 replays the secondary game based on the secondary game events comprising the secondary game history and presents the playback of the secondary game in conjunction with the playback of the primary wagering game. In another example, the secondary game history comprises a video clip of the secondary game. In this example, the secondary application server 220 plays the video clip of the secondary game to present the playback of the secondary game in conjunction with the playback of the primary wagering game at the primary wagering game server 210. In one example, the secondary application server 220 may stream the video clip of the secondary game to the game history playback unit 218 of the primary wagering game server 210, or to a wagering game machine 260. After block 510, the flow continues at block 512.

At block 512, the primary wagering game server 210 determines whether to continue replaying the primary wagering game. If the primary wagering game server 210 should not continue replaying the primary wagering game, the flow continues at block 514. Otherwise, the flow loops back to block 504, where the playback of the primary wagering game continues.

At block 514, the primary wagering game server 210 completes the playback of the primary wagering game and presents the primary wagering game results. The primary wagering game server 210 may also finish presenting the playback of the secondary game and present the results of the secondary game. After the block 514, the flow ends.

### Additional Example Operating Environments

This section describes example operating environments, systems and networks, and presents structural aspects of some embodiments.

### Wagering Game Machine Architecture

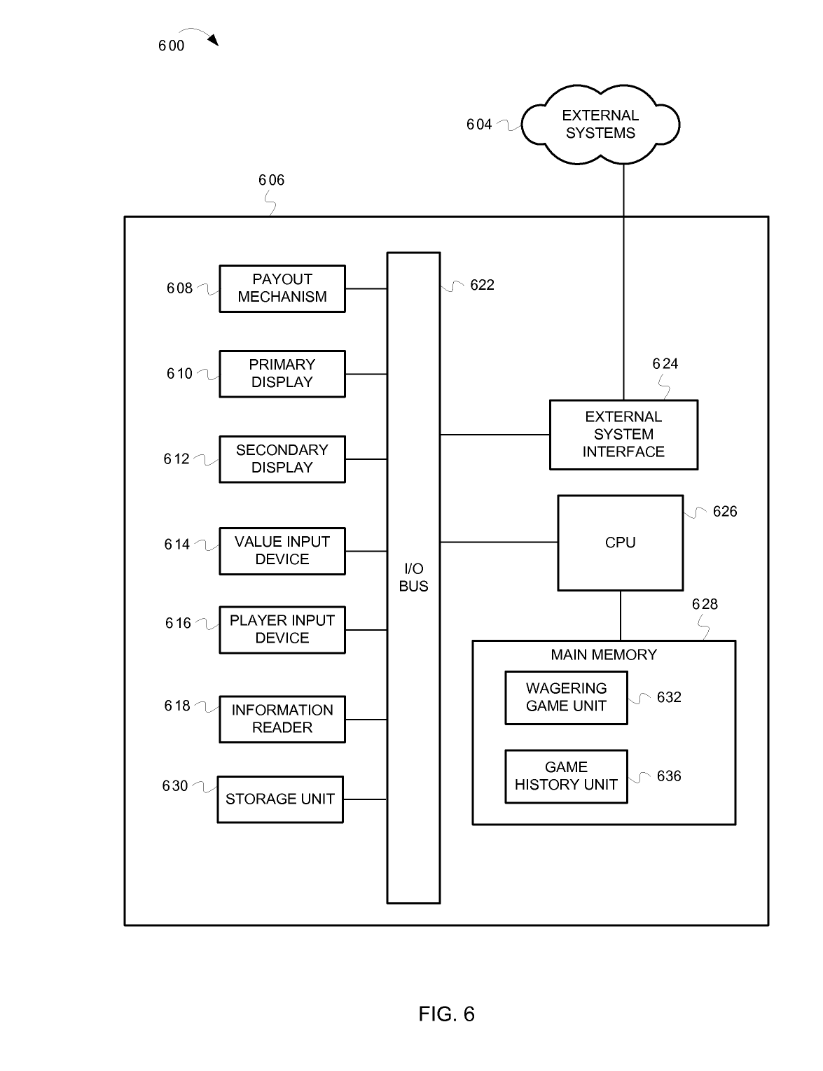

FIG. 6 is a conceptual diagram that illustrates an example of a wagering game machine architecture 600, according to some embodiments. In FIG. 6, the wagering game machine architecture 600 includes a wagering game machine 606, which includes a central processing unit (CPU) 626 connected to main memory 628. The CPU 626 can include any suitable processor, such as an Intel® Pentium processor, Intel® Core 2 Duo processor, AMD Opteron™ processor, or UltraSPARC processor. The main memory 628 includes a wagering game unit 632 and a game history unit 636. In some embodiments, the wagering game unit 632 can present wagering games, such as video poker, video black jack, video slots, video lottery, reel slots, etc., in whole or part. The game history unit can implement techniques for managing primary and secondary game history for primary wagering games and secondary games, respectively, e.g., as described above with reference to FIGS. 1-5.

The CPU 626 is also connected to an input/output (“I/O”) bus 622, which can include any suitable bus technologies, such as an AGTL+ frontside bus and a PCI backside bus. The I/O bus 622 is connected to a payout mechanism 608, primary display 610, secondary display 612, value input device 614, player input device 616, information reader 618, and storage unit 630. The player input device 616 can include the value input device 614 to the extent the player input device 616 is used to place wagers. The I/O bus 622 is also connected to an external system interface 624, which is connected to external systems (e.g., wagering game networks). The external system interface 624 can include logic for exchanging information over wired and wireless networks (e.g., 802.11g transceiver, Bluetooth transceiver, Ethernet transceiver, etc.)

In some embodiments, the wagering game machine 606 can include additional peripheral devices and/or more than one of each component shown in FIG. 6. For example, in some embodiments, the wagering game machine 606 can include multiple external system interfaces 624 and/or multiple CPUs 626. In some embodiments, any of the components can be integrated or subdivided.

In some embodiments, the wagering game machine 606 includes an online gaming module 637. The online gaming module 637 can process communications, commands, or other information, where the processing can control and present online wagering games.

Furthermore, any component of the wagering game machine 606 can include hardware, firmware, and/or machine-readable media including instructions for performing the operations described herein.

### Example Wagering Game Machines

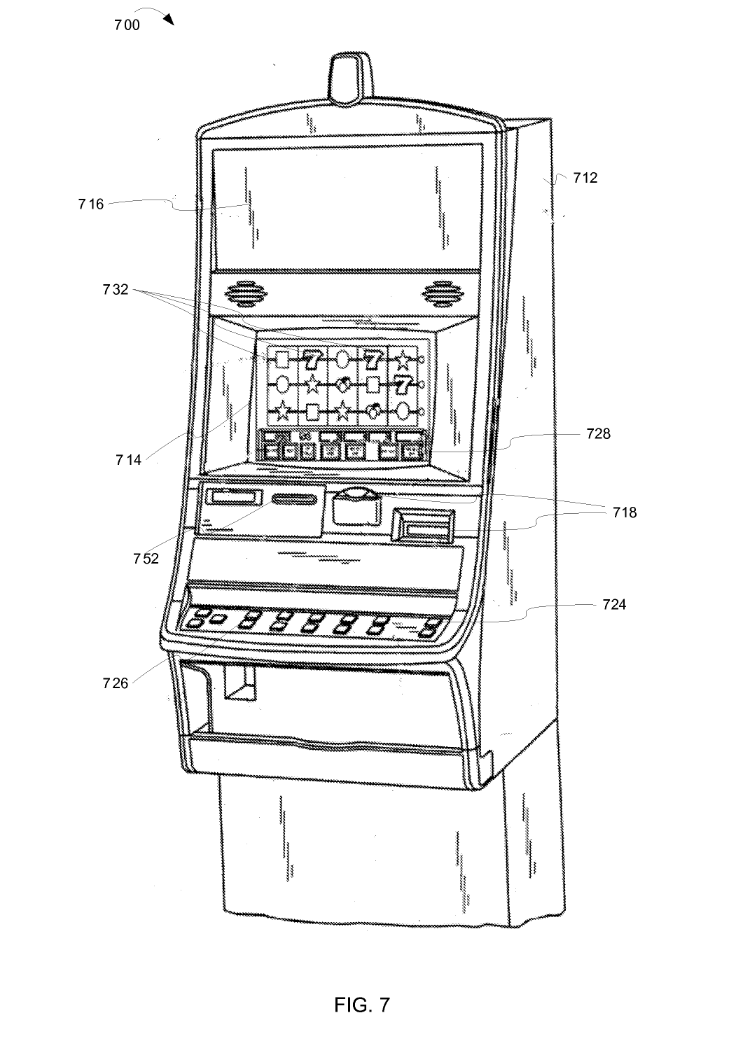

FIG. 7 is a perspective view of a wagering game machine, according to example embodiments. Referring to FIG. 7, a wagering game machine 700 is used in gaming establishments, such as casinos. In some embodiments, the wagering game machine 700 can implement the functionality described above with reference to FIGS. 1-5, e.g., managing primary and secondary game history for primary wagering games and secondary games, respectively.

According to embodiments, the wagering game machine 700 can be any type of wagering game machine and can have varying structures and methods of operation. For example, the wagering game machine 700 can be an electromechanical wagering game machine configured to play mechanical slots, or it can be an electronic wagering game machine configured to play video casino games, such as blackjack, slots, keno, poker, blackjack, roulette, etc.

The wagering game machine 700 comprises a housing 712 and includes input devices, including value input devices 718 and a player input device 724. For output, the wagering game machine 700 includes a primary display 714 for displaying information about a basic wagering game. In some implementations, the primary display 714 can also display information about a bonus wagering game and a progressive wagering game. The wagering game machine 700 also includes a secondary display 716 for displaying bonus wagering games, wagering game events, wagering game outcomes, and/or signage information. While some components of the wagering game machine 700 are described herein, numerous other elements can exist and can be used in any number or combination to create varying forms of the wagering game machine 700.

The value input devices 718 can take any suitable form and can be located on the front of the housing 712. The value input devices 718 can receive currency and/or credits inserted by a player. The value input devices 718 can include coin acceptors for receiving coin currency and bill acceptors for receiving paper currency. Furthermore, the value input devices 718 can include ticket readers or barcode scanners for reading information stored on vouchers, cards, or other tangible portable storage devices. The vouchers or cards can authorize access to central accounts, which can transfer money to the wagering game machine 700.

The player input device 724 comprises a plurality of push buttons on a button panel 726 for operating the wagering game machine 700. In addition, or alternatively, the player input device 724 can comprise a touch screen 728 mounted over the primary display 714 and/or secondary display 716.

The various components of the wagering game machine 700 can be connected directly to, or contained within, the housing 712. Alternatively, some of the wagering game machine's components can be located outside of the housing 712, while being communicatively coupled with the wagering game machine 700 using any suitable wired or wireless communication technology.

The operation of the basic wagering game can be displayed to the player on the primary display 714. The primary display 714 can also display a bonus game associated with the basic wagering game. The primary display 714 can include a cathode ray tube (CRT), a high resolution liquid crystal display (LCD), a plasma display, light emitting diodes (LEDs), or any other type of display suitable for use in the wagering game machine 700. Alternatively, the primary display 714 can include a number of mechanical reels to display the outcome. In FIG. 7, the wagering game machine 700 is an “upright” version in which the primary display 714 is oriented vertically relative to the player. Alternatively, the wagering game machine can be a “slant-top” version in which the primary display 714 is slanted at about a thirty-degree angle toward the player of the wagering game machine 700. In yet another embodiment, the wagering game machine 700 can exhibit any suitable form factor, such as a free standing model, bartop model, mobile handheld model, or workstation console model.

A player begins playing a basic wagering game by making a wager via the value input device 718. The player can initiate play by using the player input device's buttons or touch screen 728. The basic game can include arranging a plurality of symbols along a payline 732, which indicates one or more outcomes of the basic game. Such outcomes can be randomly selected in response to player input. At least one of the outcomes, which can include any variation or combination of symbols, can trigger a bonus game.

In some embodiments, the wagering game machine 700 can also include an information reader 752, which can include a card reader, ticket reader, bar code scanner, RFID transceiver, or computer readable storage medium interface. In some embodiments, the information reader 752 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the inventive subject matter, which are defined only by the appended claims. Each of the embodiments described herein are contemplated as falling within the inventive subject matter, which is set forth in the following claims.

1. A computer-implemented method comprising:
initiating, at a secondary application server of a wagering game system, a secondary game for presentation on a wagering game machine of the wagering game system, wherein the secondary game is associated with a primary wagering game being presented on the wagering game machine;
detecting, at the secondary application server, secondary game events associated with the secondary game;
generating, at the secondary application server, secondary game history based, at least in part, on the secondary game events;
generating a pointer to a storage location of the secondary game history in the secondary application server; and
providing the pointer for the secondary game history to the wagering game machine to be stored within a primary wagering game history associated with the primary wagering game.

2. The method of claim 1, wherein said generating secondary game history comprises generating a video clip of the secondary game, wherein content in the video clip is dependent on the secondary game events.

3. The method of claim 1, wherein said generating secondary game history comprises storing the secondary game events in the secondary application server for use in recreating the secondary game to replay the secondary game in conjunction with the primary wagering game in a network component of the wagering game system.

4. The method of claim 1, wherein the secondary game events include one or more of button presses, bets, credit balances, intermediate game results, and final game results.

5. The method of claim 1, wherein said detecting secondary game events comprises receiving one or more event messages from the wagering game machine indicating player input at the wagering game machine.

6. The method of claim 1, wherein said detecting secondary game events comprises detecting random numbers that are generated to determine secondary game results.

7. The method of claim 1, further comprising:
receiving, at the secondary application server, a reference to the pointer to the storage location of the secondary game history, and
providing the secondary game history for use in replaying the secondary game in conjunction with the primary wagering game in a network component of the wagering game system.

8. The method of claim 7, wherein said generating secondary game history comprises generating a video clip of the secondary game, and wherein said providing the secondary game history comprises providing the video clip of the secondary game for use in replaying the secondary game in conjunction with the primary wagering game in the network component of the wagering game system.

9. The method of claim 1, wherein the secondary game is a bonus game.

10. The method of claim 1, wherein the pointer to the storage location of the secondary game history is a Uniform Resource Locator (URL).

11. A secondary application server of a wagering game system, the secondary application server comprising:
a secondary game controller configured to initiate a secondary game on a wagering game machine of the wagering game system, wherein the secondary game is associated with a primary wagering game being presented on the wagering game machine;
a game event monitoring unit configured to detect secondary game events associated with the secondary game, and configured to generate secondary game history based, at least in part, on the secondary game events; and
a game history playback unit configured to generate a uniform resource locator (URL) identifying a storage location of the secondary game history, and configured to provide the URL to a primary wagering game server to be stored within a primary wagering game history associated with the primary wagering game.

12. The secondary application server of claim 11, wherein the game event monitoring unit is configured to generate a video clip of the secondary game being presented on the wagering game machine, wherein content in the video clip is dependent on the secondary game events.

13. The secondary application server of claim 11, wherein the game event monitoring unit is configured to store the secondary game events for use in recreating the secondary game to replay the secondary game in conjunction with the primary wagering game in a network component of the wagering game system.

14. The secondary application server of claim 12, wherein the game history playback unit is configured to receive a reference to the URL to the storage location of the secondary game history, and the game history playback unit is further configured to provide the video clip of the secondary game for use in replaying the secondary game in conjunction with the primary wagering game in a network component of the wagering game system.

15. An apparatus comprising:
means for detecting an event that triggers presentation of a secondary game on a wagering game machine;
means for initiating the secondary game for presentation on the wagering game machine, wherein the secondary game is associated with a primary wagering game being presented on the wagering game machine;
means for detecting secondary game events associated with the secondary game;
means for generating secondary game history based, at least in part, on the secondary game events;
means for generating a pointer to a storage location of the secondary game history; and
means for providing the pointer for the secondary game history to the wagering game machine to be stored within a primary wagering game history associated with the primary wagering game.

16. The apparatus of claim 15, wherein said means for generating secondary game history comprises means for generating a video clip of the secondary game, wherein content in the video clip is dependent on the secondary game events.

17. The apparatus of claim 15, wherein said means for generating secondary game history comprises means for storing the secondary game events for use in recreating the secondary game to replay the secondary game in conjunction with the primary wagering game.

18. A computer-implemented method comprising:
detecting, at a primary wagering game server of a wagering game system, a request to replay a primary wagering game previously played on a wagering game machine of the wagering game system;
accessing a primary wagering game history associated with the primary wagering game;
replaying the primary wagering game based on the primary wagering game history;
detecting a pointer to a secondary game history associated with a secondary game previously played on the wagering game machine in conjunction with the primary wagering game, wherein the pointer identifies a storage location of the secondary game history in a secondary application server of the wagering game system;
following the pointer to access the secondary game history at the storage location in the secondary application server; and
replaying the secondary game based on the secondary game history in conjunction with said replaying of the primary wagering game.

19. The method of claim 18, wherein said replaying the secondary game based on the secondary game history in conjunction with said replaying of the primary wagering game comprises playing a video clip of the secondary game in conjunction with said replaying of the primary wagering game.

20. The method of claim 18, wherein said replaying the primary wagering game and said replaying the secondary game comprises replaying the primary wagering game and replaying the secondary game at the wagering game machine.

21. The method of claim 18, wherein said replaying the primary wagering game and said replaying the secondary game comprises replaying the primary wagering game and replaying the secondary game at a terminal of the primary wagering game server.

22. One or more machine-readable storage media, having instructions stored therein, which, when executed by one or more processors causes the one or more processors to perform operations that comprise:
initiating a secondary game for presentation on a wagering game machine, wherein the secondary game is associated with a primary wagering game being presented on the wagering game machine;
detecting secondary game events associated with the secondary game;
generating secondary game history based, at least in part, on the secondary game events;
generating a pointer to a storage location of the secondary game history; and
providing the pointer for the secondary game history to the wagering game machine to be stored within a primary wagering game history associated with the primary wagering game.

23. The machine-readable storage media of claim 22, wherein said operation of generating secondary game history comprises generating a video clip of the secondary game, wherein content in the video clip is dependent on the secondary game events.

24. The machine-readable storage media of claim 22, wherein said operation of generating secondary game history comprises storing the secondary game events for use in recreating the secondary game to replay the secondary game in conjunction with the primary wagering game.

25. The machine-readable storage media of claim 22, wherein the operations further comprise:
receiving a reference to the pointer to the storage location of the secondary game history, and
providing the secondary game history for use in replaying the secondary game in conjunction with the primary wagering game.
